(19) United States
(12) Patent Application Publication
(10) Pub. No.: US 2010/0001691 A1
(43) Pub. Date: Jan. 7, 2010

(54) BATTERY ASSEMBLY

(75) Inventor: Ju-Mei Li, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/339,267

(22) Filed: Dec. 19, 2008

(30) Foreign Application Priority Data
Jul. 4, 2008 (TW) 97125434

(51) Int. Cl. H02J 7/00

(52) U.S. Cl. 320/128

(57) ABSTRACT

A battery assembly (10) is described. The battery assembly (10) includes a power storing module (11) and a charging module (12). The charging module (12) is electrically connected to the power storing module (11) and received in the power storing module (11). The charging module (12) is configured to electrically connect to an outside power source to charge the power storing module (11).

### BACKGROUND

1. Technical Field

The present disclosure relates to a battery assembly and, particularly, to a self-chargeable battery assembly.

2. Description of Related Art

With the ongoing development of technologies, electronic devices have become widely used and are typically powered by rechargeable batteries.

However, rechargeable batteries require a battery charger for charging battery assembly, and the battery charger is big, clunky and inconvenient to carry.

Therefore, there is room for improvement within the art.

### BRIEF DESCRIPTION OF THE DRAWINGS

Many aspects of the battery assembly can be better understood with reference to the following drawings. These drawings are not necessarily drawn to scale, the emphasis instead being placed upon clearly illustrating the principles of the present battery assembly. Moreover, in the drawings like reference numerals designate corresponding sections throughout the several views.

FIG. 1 is an isometric view of a battery assembly, in accordance with an exemplary embodiment.

FIG. 2 is a function block diagram showing a battery assembly shown in FIG. 1.

FIG. 3 is a circuit block diagram of a charging module shown in FIG. 2.

### DETAILED DESCRIPTION OF EXEMPLARY EMBODIMENT

The present battery assembly is suitable for portable electronic devices, such as mobile phone terminals, digital cameras, and so on.

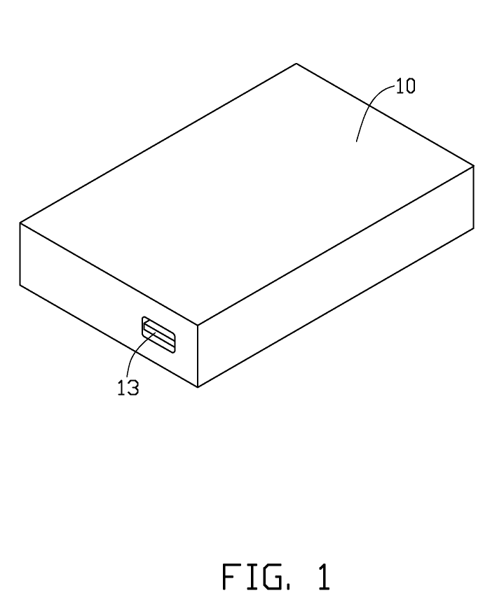

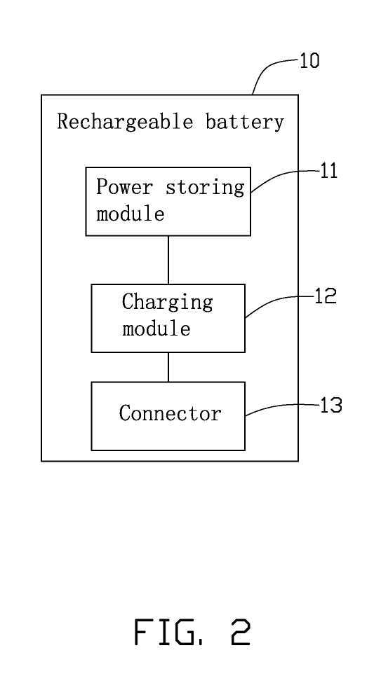

FIGS. 1 and 2 show an exemplary battery assembly 10. The battery assembly 10 includes a power storing module 11 and a charging module 12. The charging module 12 is electrically connected to and received in the power storing module 11.

The power storing module 11 may be a typical rechargeable battery (e.g., lithium-ion battery or nickel-ion battery). The power storing module 11 has a connector 13 to electrically connect to an outside power source (e.g., alternating current (AC) power source). The connector 13 may be an universal serial bus connector (USB) and is configured to electrically connect to the outside power source.

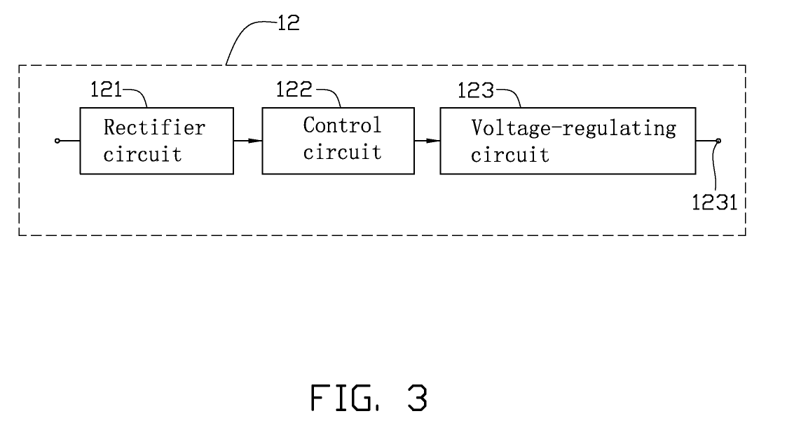

Referring to FIG. 3, the charging module 12 has a charging circuit (not labeled). The charging circuit includes a rectifier circuit 121, a control circuit 122 and a voltage-regulating circuit 123.

The rectifier circuit 121 electrically connects to the outside power source via the connector 13 and can transform alternating current (AC) input from the outside power source to direct current (DC) output.

The control circuit 122 electrically connects to the rectifier circuit 121 and can stabilize the output voltage of the rectifier circuit 121.

The voltage-regulating circuit 123 includes an output end 1231. The output end 1231 is electrically connected to the power storing module 11. The voltage-regulating circuit 123 can regulate the voltage of the output end 1231 during charging of the power storing module 11.

In use, the connector 13 can be electrically connected to the outside power source. The outside power source works to charge the power storing module 11 through the charging module 12.

The present battery assembly 10 incorporates the charging module 12 therein, thus users can easily charge the battery assembly 10 without using a big, clunky battery charger.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of sections within the principles of the invention to the full extent indicated by the broad general meaning of the terms, in which the appended claims are expressed.

What is claimed is:

1. A battery assembly, comprising:
a power storing module; and
a charging module electrically connected to the power storing module and received in the power storing module, the charging module being configured to electrically connect to an outside power source to charge the power storing module.

2. The battery assembly as claimed in claim 1, wherein the power storing module is a lithium-ion battery or nickel-ion battery.

3. The battery assembly as claimed in claim 1, wherein the charging module has a charging circuit including a rectifier circuit, a control circuit and a voltage-regulating circuit.

4. The battery assembly as claimed in claim 3, wherein the rectifier circuit is adapted to electrically connect to the outside power source and transforms alternating current input to direct current output.

5. The battery assembly as claimed in claim 3, wherein the control circuit is electrically connected to the rectifier circuit, and can stabilize the output voltage of the rectifier circuit.

6. The battery assembly as claimed in claim 3, wherein the voltage-regulating circuit has an output end, the output end is electrically connected to the power storing module, the voltage-regulating circuit can regulate the voltage of the output end to charge the power storing module.
